(19) United States
(12) Patent Application Publication
(10) Pub. No.: US 2005/0289302 A1
(43) Pub. Date: Dec. 29, 2005

(54) Multiple processor cache intervention associated with a shared memory unit

(76) Inventors: Peter J. Barry, Clare (IE); Seamus N. Murnane, Limerick (IE)

Correspondence Address: BUCKLEY, MASCHOFF, TALWALKAR LLC, 5 ELM STREET, NEW CANAAN, CT, 06840, US

(21) Appl. No.: 10/878,908

(22) Filed: Jun. 28, 2004

(51) Int. Cl. G06F 12/00

(52) U.S. Cl. 711/144; 711/145; 711/146

(57) ABSTRACT

According to some embodiments, multiple processor cache intervention is provided in connection with a shared memory unit.

### BACKGROUND

A processing system may include multiple processors that access and/or modify information stored in a shared memory unit. For example, a processing system might receive packets of information and store the packets in a shared memory unit. One or more processors in the processing system may then retrieve the information in the shared memory unit and modify the information as appropriate (e.g., by modifying a packet header to facilitate the transmission of the packet to a destination).

To improve performance, a processor may locally store a copy of the information in the shared memory unit. For example, a processor might copy information into a local cache memory that can be accessed in fewer clock cycles as compared to the shared memory unit. In this case, the processing system may manage memory transactions to provide information consistency and coherency. For example, when one processor modifies a copy of information in a local cache memory, the processing system may ensure that another processor does not access or modify an outdated copy of the information (e.g., from a shared memory unit).

### BRIEF DESCRIPTION OF THE DRAWINGS

FIG. 1 is a block diagram overview of a processing system according to some embodiments.

FIG. 2 is a flow chart of a method according to some embodiments.

FIG. 3 is an information flow diagram according to some embodiments.

FIG. 4 represents a portion of a memory management unit control table according to one embodiment.

FIG. 5 is a flow chart of a method using information in a control table according to some embodiments.

FIG. 6 is a block diagram of a system according to some embodiments.

### DETAILED DESCRIPTION

Some embodiments described herein are associated with a “processing system.” As used herein, the phrase “processing system” may refer to any device that processes data. Examples of processing systems include network processors, switches, routers, and servers.

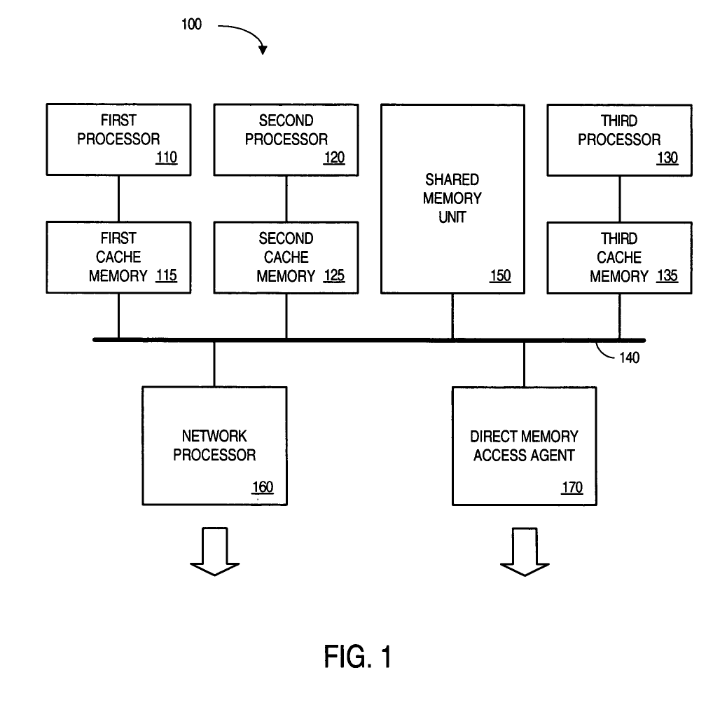

FIG. 1 is a block diagram overview of a processing system 100 according to some embodiments. The processing system 100 includes a first processor 110, such as an INTEL® XScale® processor. The first processor 110 is associated with a first cache memory 115. The first cache memory 115 might comprise, for example, a separate Level 2 (L2) Static Random Access Memory (SRAM) chip or a Level 1 (L2) cache memory on the same die as the first processor 110.

The first processor 110 may exchange information with a shared memory unit 150, such as a Dynamic Random Access Memory (DRAM) unit, via a system bus or backplane bus 140. For example, the first processor 110 may copy information from the shared memory unit 150 into the first cache memory 115 (e.g., to improve the performance of the processing system 100 when data in the first cache memory 115 can be accessed by the first processor 110 in fewer clock cycles as compared to the shared memory unit 150).

According to some embodiments, the processing system 100 includes multiple processors that are able to exchange information with the shared memory unit 150. For example, as illustrated in FIG. 1 the system 100 might include a second processor 120 and third processor 130 (along with an associated second cache memory 125 and third cache memory 135). Similarly, the processing system 100 might also include a network processor 160 and/or a Direct Memory Access (DMA) agent 170. The DMA agent 170 might, for example, facilitate an exchange of information between the shared memory unit 150 and another device.

The processing system 100 may need to manage memory transactions to provide information consistency and coherency. For example, the first processor 110 might copy a memory portion (e.g., a word or line of data) from the shared memory unit 150 to the first cache memory 115 and then modify the information in the first cache memory 115. In this case, the processing system 100 might prevent the second processor 120 from accessing the outdated information in the shared memory unit 150.

In some memory management approaches, the first processor 110 determines that another processor is attempting to access outdated information in the shared memory unit 150. The first processor 110 then intervenes and provides the more recent data directly from the first cache memory 115 to the other processor. In addition, the first processor 110 updates the information in the shared memory unit 150 (e.g., by writing back the line of data so that other processors can subsequently access the more recent data from the shared memory unit 150). For example, the first processor 110 might update the information in the shared memory unit 150 when the first cache memory 115 needs to store other information in that line.

Note, however, that in some cases the updated information in the shared memory unit 150 will never be subsequently accessed. For example, a network processor 160 or a DMA agent 170 might retrieve and transmit a packet of information. As a result, the update of the shared memory unit 150 performed by the first processor 110 might be unnecessary and reduce the performance of the processing system 100.

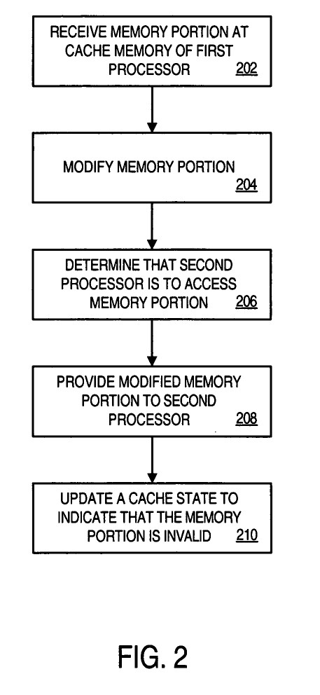

FIG. 2 is a flow chart of a method according to some embodiments. The flow charts described herein do not necessarily imply a fixed order to the actions, and embodiments may be performed in any order that is practicable. Note that any of the methods described herein may be performed by hardware, software (including microcode), firmware, or any combination of these approaches. For example, a storage medium may store thereon instructions that when executed by a machine result in performance according to any of the embodiments described herein.

At 202, a memory portion is received at a cache memory of a first processor. For example, in FIG. 1 the first processor 110 might copy a line of data associated with an information packet from the shared memory unit 150 to the first cache memory 115. At 204, the memory portion is modified. For example, the first processor 110 might modify a line of data in the first cache memory 115 associated with a packet header.

It is determined at 206 that a second processor is to access the memory portion. For example, the first processor 110 might determine that the network processor 160 is to access the line of data from the shared memory unit 150 (e.g., the outdated version of the data). The modified memory portion is then provided to the second processor at 208. For example, the first processor 110 might transmit the modified line of data directly from the first cache memory 115 to the network processor (referred to as a “direct data intervention”).

A cache state is then updated to indicate that the memory portion is invalid at 210. For example, the first processor 110 may update a status associated with a line of data to “invalid” without updating the line of data in the shared memory unit 150. This might be appropriate when the line of data was associated with a packet that is being transmitted from the network processor 160 (and, as a result, the data will not be subsequently used by the processing system 100).

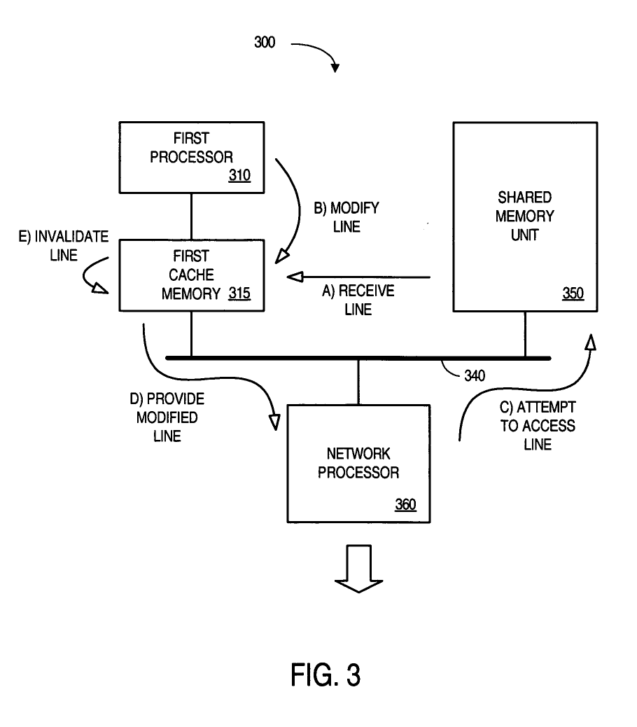

FIG. 3 is an information flow diagram 300 according to some embodiments. At A, a first processor 310 receives a line of data from a shared memory unit 350 via a system bus 340. For example, the first processor 310 might copy a line of data associated with an information packet into a first cache memory 315. At B, the first processor 310 modifies the line of data stored in the first cache memory 315 (e.g., by updating a packet header).

A network processor 360 then attempts to access that line of data from the shared memory unit 350 at C. In response to this attempt, the first processor 310 transmits the data in the first cache memory 315 directly to the network processor 160 at D. At E, the first processor 310 updates a cache state to indicate that the line of information is no longer valid. That is, the first processor 310 does not copy the current line of data from the first cache memory 315 to the shared memory unit 350. This might be appropriate, for example, when the line of data will not need to be accessed again.

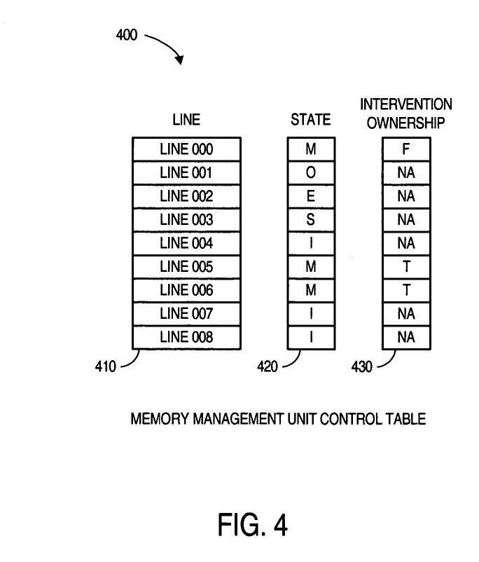

According to some embodiments, information in a Memory Management Unit (MMU) may be used to determine whether a line of data in a shared memory unit should be (i) updated or (ii) invalidated. FIG. 4 represents a portion of a MMU control table 400 according to one embodiment. The control table 400 might, for example, be associated with a hardware and/or software structure stored at a shared memory unit.

Each line of data 410 in the control table 400 is associated with a cache coherence state 420. Some embodiments described herein may be associated with a Modified, Owned, Exclusive, Shared, Invalid (MOESI) protocol defined by the Institute of Electrical and Electronics Engineers (IEEE) standard number 896 entitled “Futurebus+” (1993). In this case, a state 420 of “I” (invalid) indicates that the associated line of data 410 is currently empty. Moreover, a state 420 of “M” (modified) indicates that a more recent copy of the associated line of data 410 exists in a processor's cache memory.

According to this embodiment, intervention ownership information 430 is also stored in the control table 400. In particular, when the state 420 is “M,” the intervention ownership information 430 may be set to “F” (false) to indicate that the associated line of data 410 should be updated after a processor provides modified data to another processor. When the state 420 is “M,” the intervention ownership information 430 may be set to “T” (true) to indicate that the associated line of data 410 should be invalidated after a processor provides modified data to another processor. When the state 420 is not “M,” the intervention ownership information 430 may not be applicable (“NA”).

The intervention ownership information 430 may, for example, be initialized and/or updated by an Operating System (OS) as appropriate based on the type of information being stored in the associated lines of data 410 (e.g., when the OS sets up memory management page tables in accordance with memory management and/or buffer allocation policies). For example, the intervention ownership information 430 might be set to “T” for portions of a shared memory unit that will be used to store packet buffer pools and to “F” for other portions.

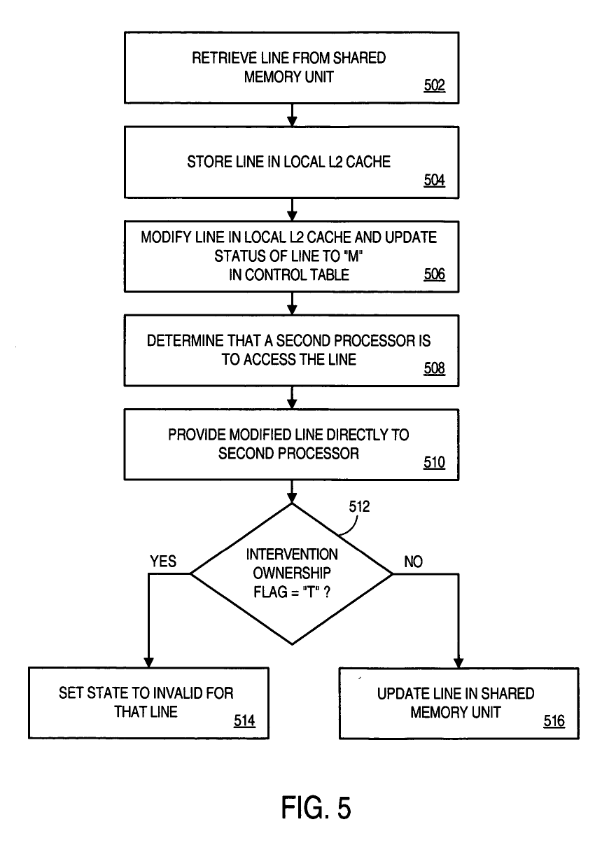

FIG. 5 is a flow chart of a method using information in the MMU control table 400 according to some embodiments. At 502, a line of data is retrieved from a shared memory unit, and the data is stored into a first processor's local L2 cache memory at 504.

At 506, the line of data in the L2 cache memory is modified and the status of that line of data is updated to “M” in the control table 400 (to indicate that the line of data has been modified and the version of the data in the shared memory unit is outdated).

At 508, it is determined that a second processor is to access the line of data, and the first processor provides the modified line of data from the L2 cache memory to the second processor at 510.

At 512, the first processor accesses the intervention ownership information 430 in the MMU control table 400. If the intervention ownership information 430 is not set to “T,” the information in the shared memory unit is updated at 516 (e.g., the modified line of data is eventually written back into the shared memory unit).

If the intervention ownership information 430 is set to “T,” the state 420 of that line of data is set to “I” (invalid) without updating the information in the shared memory unit at 514. Note that the state 420 might not be immediate set to “I.” For example, the state 420 of that line of data may initially be set to “O” and then later to “I.”

Thus, embodiments may reduce the system bus bandwidth usage that is associated with unnecessary write backs to a shared memory unit. Consider, for example, an apparatus that receives and stores a packet of information to be routed. In this case, a first processor might read the packet from a shared memory unit to the first processor's cache memory and modify the packet header. A network processor may then receive a transmission request for that packet and attempt to retrieve the packet. The first processor would then provide the packet (with the modified header) to the network processor and invalidate the associated lines of data in the shared memory unit. The network processor may then transmit the packet with the modified header.

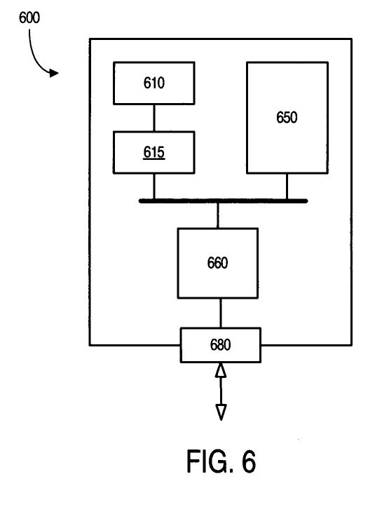

FIG. 6 is a block diagram of a system 600 according to some embodiments. The system 600 might be associated with, for example, a network processor that receives information packets, modifies packet headers, and transmits information packets as appropriate. The system 600 includes a first processor 610 that is able to access a local cache memory 615 and a shared SRAM unit 650. The system also includes a network processor 660 adapted to exchange information packets via a port 680. The system 600 may operate in accordance with any of the embodiments herein. For example, intervention ownership information might be stored in a control table at the shared SRAM unit 650.

The following illustrates various additional embodiments. These do not constitute a definition of all possible embodiments, and those skilled in the art will understand that many other embodiments are possible. Further, although the following embodiments are briefly described for clarity, those skilled in the art will understand how to make any changes, if necessary, to the above description to accommodate these and other embodiments and applications.

According to some embodiments, the information ownership information is stored separately from the cache coherency state. Note, however, that in any embodiment the information ownership information may be stored within the cache coherency state. For example, an “M1” state might indicate that a line of data should be updated and an “M2” state might indicate that the line of data should be invalidated after being modified and provided to another processor.

Moreover, although embodiments have been described with respect to an MOESI cache coherency protocol, embodiments may be associated with other types of cache coherency protocols (e.g., an MEI or MSI protocol).

The several embodiments described herein are solely for the purpose of illustration. Persons skilled in the art will recognize from this description other embodiments may be practiced with modifications and alterations limited only by the claims.

1. A method, comprising:
receiving, at a cache memory of a first processor, a memory portion from a shared memory unit;
modifying the memory portion;
determining that a second processor is to access the memory portion;
providing the modified memory portion to the second processor; and
updating a cache state to indicate that the memory portion is invalid.

2. The method of claim 1, further comprising:
accessing intervention ownership information associated with the memory portion, wherein the cache state is updated in accordance with the intervention ownership information.

3. The method of claim 2, further comprising:
receiving, at the cache memory of the first processor, a second memory portion from the shared memory unit;
modifying the second memory portion;
accessing intervention ownership information associated with the second memory portion;
determining that another processor is to access the second memory portion;
providing the second modified memory portion to the other processor; and
updating the second memory portion in the shared memory unit with the second modified memory portion.

4. The method of claim 2, wherein the cache state is a cache coherence state and the intervention ownership information is stored in a memory management unit control table along with the cache coherence state.

5. The method of claim 1, wherein the memory portion comprises a line of data.

6. The method of claim 1, wherein the second processor comprises at least one of a network processor or a direct memory access agent.

7. The method of claim 1, wherein the memory portion is associated with an information packet.

8. An apparatus, comprising:
a local cache to store a memory portion received from a shared memory unit; and
a processor to (i) modify the memory portion, (ii) determine that another processor is to access the memory portion, (iii) provide the modified memory portion to the other processor, and (iv) update a cache state to indicate that the memory portion is invalid.

9. The apparatus of claim 8, wherein the local cache is a level two cache.

10. The apparatus of claim 8, wherein the processor is further to access intervention ownership information associated with the memory portion, and the cache state is updated in accordance with the intervention ownership information.

11. The apparatus of claim 10, wherein the cache state is a cache coherence state and the intervention ownership information is stored in a memory management unit control table along with the cache coherence state.

12. The apparatus of claim 8, wherein the memory portion is associated with an information packet and the other processor comprises at least one of a network processor or a direct memory access agent.

13. An article, comprising:
a storage medium having stored thereon instructions that when executed by a machine result in the following:
receiving, at a cache memory of a first processor, a memory portion from a shared memory unit,
modifying the memory portion,
determining that a second processor is to access the memory portion,
providing the modified memory portion to the second processor, and
updating a cache state to indicate that the memory portion is invalid.

14. The article of claim 13, wherein execution of the instructions further results in:
accessing intervention ownership information associated with the memory portion, and the cache state is updated in accordance with the intervention ownership information.

15. The article of claim 14, wherein execution of the instructions further results in:
receiving, at the cache memory of the first processor, a second memory portion from the shared memory unit,
modifying the second memory portion,
accessing intervention ownership information associated with the second memory portion,
determining that another processor is to access the second memory portion,
providing the second modified memory portion to the other processor, and
updating the second memory portion in the shared memory unit with the second modified memory portion.

16. The article of claim 15, wherein the cache state is a cache coherence state and intervention ownership information is stored in a memory management unit control table along with the cache coherence state.

17. The method of claim 1, wherein the memory portion is associated with an information packet and the second processor comprises at least one of a network processor or a direct memory access agent.

18. A system, comprising:
a shared static random access memory unit to store a memory portion;
a first processing unit, including:
a local cache to store the memory portion received from the shared memory unit, and
a processor to (i) modify the memory portion, (ii) determine that another processor is to access the memory portion, (iii) provide the modified memory portion to the other processor, and (iv) update a cache state to indicate that the memory portion is invalid; and
a second processing unit.

19. The system of claim 18, wherein the first processor is further to access intervention ownership information associated with the memory portion, and the cache state is to be updated in accordance with the intervention ownership information.

20. The system of claim 19, wherein the cache state is a cache coherence state and the intervention ownership information is stored in a memory management unit control table along with the cache coherence state.

21. The system of claim 18, wherein the memory portion is associated with an information packet and the second processor comprises at least one of a network processor or a direct memory access agent.
